(19) United States
(12) Patent Application Publication
(10) Pub. No.: US 2009/0022050 A1
(43) Pub. Date: Jan. 22, 2009

(54) OFDM MODULATION DEVICE, OFDM DEMODULATION DEVICE, OFDM MODULATION METHOD, AND OFDM DEMODULATION METHOD

(75) Inventor: Genichiro Ohta, Kanagawa (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: MATSUSHITA ELECTRIC INDUSTRIAL CO., LTD., Kadoma-shi, Osaka (JP)

(21) Appl. No.: 11/814,565

(22) PCT Filed: Jan. 23, 2006
(86) PCT No.: PCT/JP2006/300976

§ 371 Date: Jul. 23, 2007

(30) Foreign Application Priority Data
Jan. 24, 2005 (JP) 2005-015835

(51) Int. Cl. H04J 11/00

(52) U.S. Cl. 370/210

(57) ABSTRACT

It is possible to form an OFDM signal improving frequency use efficiency. An OFDM modulation apparatus includes Nyquist filters (104, 126) for Nyquist-shaping signals (S10, S20) of two systems, delay apparatuses (123, 124) for delaying a signal of one system at ½ of the symbol period T, inverse Fourier transformers (105, 127) for OFDM-processing the respective signals after the Nyquist formation, and a switching section (130) combining the signals of the two systems by selectively outputting the signals of the two systems subjected to the OFDM processing while switching the signals at a ½ interval of the symbol period. Thus, it is possible to multiplex the two OFDM signals without interfering each other. As a result, it is possible to realize an OFDM modulation device (100) reaching twice as much as frequency use efficiency as compared to the conventional OFDM signal (i.e., reaching twice as much as the information transmission with the same frequency band as the conventional one.)

### TECHNICAL FIELD

The present invention relates to an OFDM modulation technique for improving frequency use efficiency.

### BACKGROUND ART

Recently, for spread of an information processing technique and rapid development of IT (Information Technology) society, demand for and expansion of information and communication is very remarkable. It is demanded that a communication infrastructure that connects an individual with a society in addition to among societies, is capable of high-speed and wireless communication. This increasing demand for mobile communication dries up rich frequency resources.

Now, so-called space-division multiplexing communication is studied as a technique, such as MIMO (Multi Input Multi Output), for improving frequency efficiency by transmitting modulated signals through a plurality of antennas. That is, by using a plurality of channels formed between transmission antennas and reception antennas, the individuality between modulated signals is secured as much as possible, so that frequency use efficiency is improved.

However, because space-division multiplexing communication such as this utilizes a channel environment which changes over time, it is necessary not only at a base station but also at a terminal apparatus of an end user to perform a great amount of signal processing. It naturally follows that that output voltage is increased, an apparatus becomes heavy and large and a cost goes up as a result.

For example, by using vertical polarization and horizontal polarization, it is possible to send various information at the same frequency. Therefore, by using QPSK on various information, theoretically it is possible to achieve 4 bit/sec/Hz at maximum. However, signal processing for optimally utilizing the orthogonality (individuality) of vertical polarization and horizontal polarization on the receiving side from reflected waves, in the mobile environment, requires twice as many apparatuses as before. In addition, signal processing takes on heavy burden for extracting parameters for following changes in the environment over time.

It would be very difficult to realize N times faster transmission rate by using N antennas, because not only N times quantity and signal processing are required but also N radio channels are required.

Therefore, instead of taking the advantage of a channel environment which changes over time, basically, there is a priority to improve modulation efficiency in the baseband radiating in free space.

Current modulation schemes in mobile communication are based on quadrature phase modulation, commonly referred to as “digital communication”, and obtains the highest frequency use efficiency at present. Major ones include quadrature amplitude modulation (QAM) and orthogonal frequency division multiplexing communication scheme using quadrature amplitude modulation for first modulation. The frequency use efficiency for an OFDM scheme utilizing QPSK, which is a base of orthogonal multiplexing and which does not apply multiple values to amplitude, is 2 bits/sec/Hz. That is, the current maximum value of a frequency use efficiency technique in the baseband is 2 bit/sec/Hz.

FIG. 1 shows a conventional principal of OFDM modulation. FIG. 1 shows a case where the number of a plurality of base modulated waves forming an OFDM signal, commonly referred to as “subcarriers”, is four. These subcarriers may be referred to as ch-1, ch-2, ch-3 and ch-4, respectively, and each subcarrier assumes a position where the subcarrier's edges and center of the bandwidth overlap with adjoining subcarriers. This is realized by using the physical property called orthogonality of frequency. For this orthogonality of frequency, the modulation speed of subcarriers should be same. In OFDM, by adjusting the modulation speed of subcarriers, overlaps in the frequency domain does not cause interference of signals, so that frequency use efficiency is improved.

FIG. 2 shows the waveform of a baseband signal (FIG. 2A) and frequency spectrum of a baseband signal (FIG. 2B) in conventional OFDM. In conventional OFDM, a pulse wave which is not filtered is used as a baseband signal and its frequency spectrum is represented in the form of sinc function. That is, where pulse width or a symbol period is represented as T, the ratio of circumference of a circle to its diameter is represented π, and ω₀T=π holds. Further, frequency spectrum is represented as frequency property F_{carrier}(ω) of the following equation which employs its angular frequency ω₀ and is represented as shown in FIG. 2B;

$$\begin{matrix}[ 1 ] & \\ {F}_{carrier} ( ω ) = \frac{sin {ω}_{0} t}{{ω}_{0} t} & ( Equation 1 )\end{matrix}$$

The spectrum assumes only positive values shown in FIG. 2B, and the portions of broken lines stuck out in the positive domain are negative value parts.

OFDM modulation performs multiplexing by placing the center of another spectrum at the position of ω₀. Accordingly, when the number of subcarriers is sufficiently large, the average frequency density becomes ω₀ per symbol.

FIG. 3 shows a configuration of conventional, typical OFDM modulating apparatus for generating this OFDM wave.

Input signal S1 which is the target of first modulation (digital quadrature modulation) is inputted to encoding section 3. Input signal S1 has I axis signal 1 and Q axis signal 2. Encoding section 3 encodes input signal S1 to add error robustness and converts encoded input signal S1 to N parallel signals corresponding to the number of OFDM subcarriers. N parallel signals in both the I domain and Q domain modulated and converted by encoding section 3 are provided to inverse Fourier transformer 4. Inverse Fourier transformer 4 forms digital signals in the I domain and digital signals of the Q domain constituting N subcarriers.

These digital signals are converted to digital signals by digital-to-analogue (D/A) converters 5 and 6. After unnecessary frequency components are canceled by filters 7 and 8, these analogue signals are inputted to quadrature modulation section 20.

Quadrature modulation section 20 multiplies a cosine wave supplied from frequency source 11 providing a central frequency of OFDM with an I axis signal at modulator 9 and, multiplies a sine wave shifted by π/2 of the phase by phase shifter 12, to a cosine wave of frequency source 11 with a Q axis signal at modulator 10, thereby performing quadrature modulation of a cosine wave and a sine wave. After modulated outputs are added and then are canceled unnecessary frequency components by third filter 13, modulated signal 14 of OFDM is obtained.

FIG. 4 shows a configuration of an OFDM demodulating apparatus for demodulating a conventional OFDM modulated wave. Demodulated input 21 as a demodulation target is inputted to quadrature detector 40 through filter 22 for canceling unnecessary frequency components. Quadrature detection section 40 multiplexes a cosine wave generated at detection frequency source 25 in quadrature detector 23 with an input signal. Quadrature detection section 40 multiplexes a sine wave outputted from π/2 phase shifter 26 in quadrature detector 24 with an input signal. In this manner, signals that are orthogonal each other are extracted by quadrature detection section 40.

After unnecessary frequency components are canceled by filters 27 and 28, detected outputs outputted from quadrature detection section 40 are provided respectively to analogue-to-digital (A/D) converters 29 and 30. Digitized signals are provided to Fourier transformer 31 from A/Ds 29 and 30. Fourier transformer 31 performs OFDM demodulation by Fourier transforming input signals. OFDM demodulated outputs transformed from a frequency domain signal to a time domain signal by Fourier transformer 31 is decoded and converted to serial signals by decoder 32. As a result, demodulated I axis signal 33 and demodulated Q axis signal 34 are outputted from decoder 32. Thus, demodulated I axis signal 33 and demodulated Q axis signal 34 corresponding respectively to I axis input 1 and Q axis input 2 shown in FIG. 3 are decoded.

FIG. 5 shows a frequency spectrum of an OFDM modulated signal with four subcarriers. FIG. 6 shows an example of a waveform in the time domain. FIG. 5 shows that a spectrum with four subcarriers forms a trapezoid. FIG. 6 also shows that a waveform in the time domain shows signals aligned without a break. These examples illustrate that a symbol period is per 4 second and bandwidth of subcarriers is 0.25 Hz. Because an OFDM modulated signal has four bound subcarriers and both ends stick out, entire frequency bandwidth is 1.25 Hz.

### Non-Patent Reference 1: The Technical Report of The Institute of Electronics, Information and Communication Engineers Vol. 104 No. 258

### DISCLOSURE OF INVENTION

### Means for Solving the Problem

In an OFDM scheme, subcarriers can be arranged such that subcarriers are overlapped by ½, so that it is possible to improve frequency use efficiency. However, an OFDM scheme uses bare, unformatted pulse sequences as input signals, and so each individual carrier (that is, subcarrier) forming an OFDM signal requires twice as much bandwidth as the Nyquist frequency twice the transmission rate. It is desirable to improve much better frequency use efficiency by performing limitation of bandwidth on a pulse wave.

It is an object of the present invention to provide an OFDM modulating apparatus, OFDM demodulating apparatus, OFDM modulating method, and OFDM demodulating method that make it possible generating an OFDM signal with improved frequency use efficiency.

### Problems to be Solved by the Invention

According to an embodiment of the present invention, OFDM modulating apparatus employs a configuration including: a Nyquist formation section that performs Nyquist formation of a first pulse signal and a second pulse signal; an inverse Fourier transform section that performs inverse Fourier transform on the first pulse signal and the second pulse signal after the Nyquist formation and obtains a first orthogonal frequency division multiplexing signal and a second orthogonal frequency division multiplexing signal; a delay section that gives a delay of half of a symbol period of an orthogonal frequency division multiplexing symbol between the first orthogonal frequency division multiplexing signal and the second orthogonal frequency division multiplexing signal; and a synthesizing section that switches and selects between the first orthogonal frequency division multiplexing signal and the second orthogonal frequency division multiplexing signal with the delay of half of the symbol period of the orthogonal frequency division multiplexing symbol at every half of the symbol period of the orthogonal frequency division multiplexing symbol and synthesizes the selected orthogonal frequency division multiplexing signal.

According to this configuration, by forming an OFDM signal after Nyquist formation, one frequency channel can be accommodated in approximately ½ of the bandwidth of a conventional OFDM wave, and, when modulation is performed using a carrier, a null can be provided at every ½ time of the symbol period. In addition, it is possible to reduce voltage at both ends remarkably, so that cutoff of both ends does not cause remarkably decreasing symbol error. Two such OFDM signals (first OFDM signal and second OFDM signal) are generated using a Nyquist formation means, a first inverse Fourier transform means and a second Fourier transform means, and, moreover, differential delay of ½ of the symbol period is provided between the OFDM signals by a delayer and then the OFDM signals are switched and selected at every ½ of the symbol period by a synthesizing means, so that symbol error due to cutoff is prevented and two OFDM signals can be accommodated in the conventional, same bandwidth. As a result, two OFDM signals can be accommodated in good condition in the bandwidth required that was conventionally required to transmit one OFDM signal, so that it is possible to transmit twice as much information as before in the same, conventional bandwidth.

According to an embodiment of the present invention, OFDM modulating apparatus employs a configuration wherein the synthesizing section keeps a portion of an orthogonal frequency division multiplexing signal before and after a switching time and synthesizes the first orthogonal frequency division multiplexing signal and the second orthogonal frequency division multiplexing signal such that the first orthogonal frequency division multiplexing signal and the second orthogonal frequency division multiplexing signal partially overlap.

According to this configuration, more original OFDM signals can be kept in proportion to the overlap, so that it is possible to further reduce symbol error.

According to an embodiment of the present invention, OFDM demodulating apparatus employs a configuration including: a first Fourier transform section and a second Fourier transform section; and a switching section for selectively switching a received orthogonal frequency division multiplexing modulated signal at half of a symbol period of an orthogonal frequency division multiplexing symbol to the first Fourier transform section or the second Fourier transform section.

According to this configuration, it is possible to demodulate OFDM signals generated by an OFDM modulating apparatus of the present invention in good condition.

### ADVANTAGEOUS EFFECT OF THE INVENTION

According to the present invention, it is possible to form an OFDM signal with improved frequency use efficiency.

### BRIEF DESCRIPTION OF DRAWINGS

FIG. 1 illustrates a principle of conventional OFDM modulation;

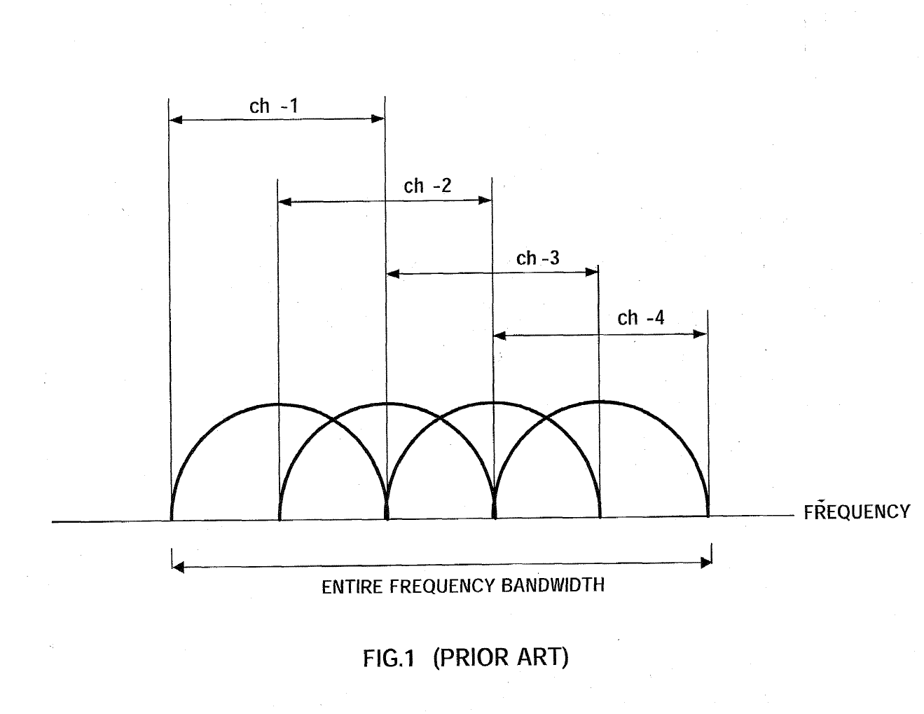

FIG. 2 shows a waveform (FIG. 2A) and a frequency spectrum (FIG. 2B) of a baseband signal in conventional OFDM;

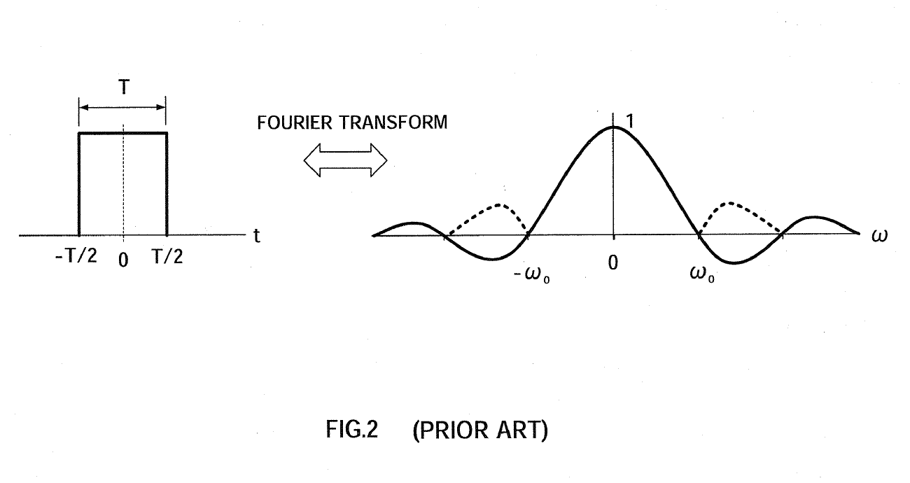

FIG. 3 is a block diagram showing a conventional OFDM modulating apparatus;

FIG. 4 shows a configuration of a conventional OFDM apparatus;

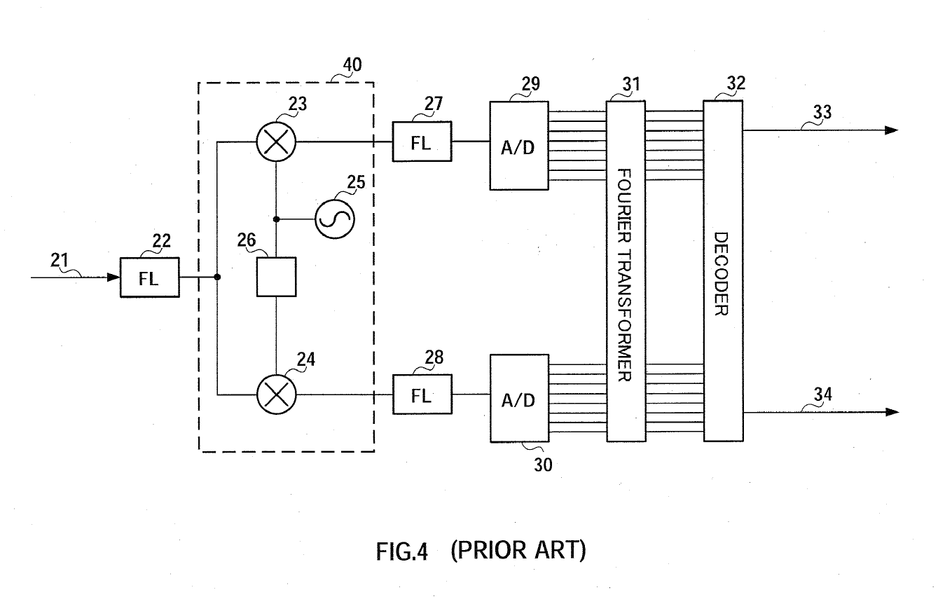

FIG. 5 shows a frequency spectrum of an OFDM modulated signal;

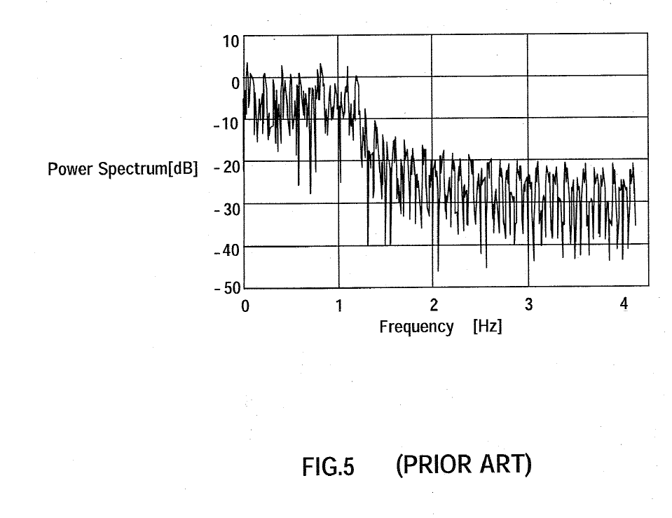

FIG. 6 shows a waveform in the time domain of an OFDM modulated signal;

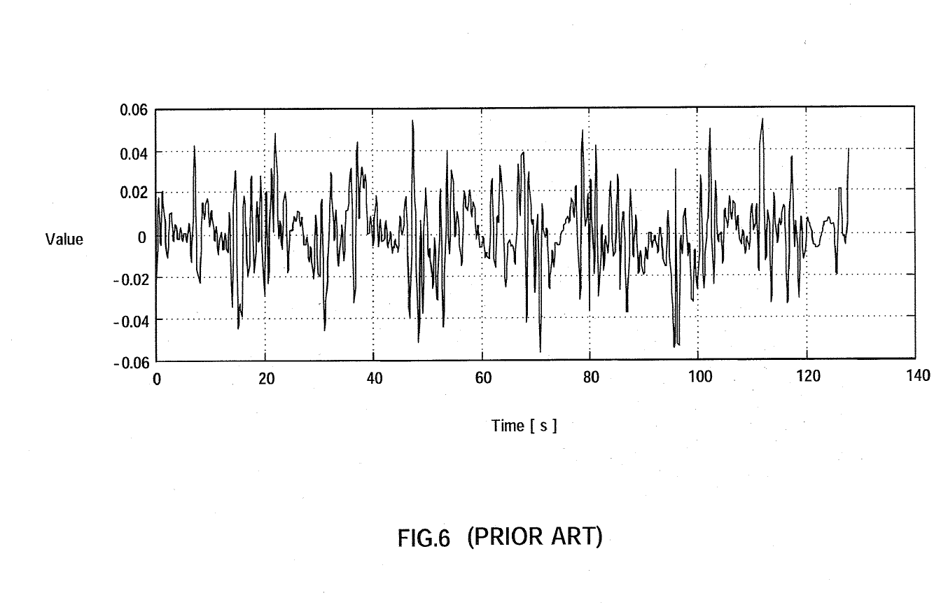

FIG. 7 is a block diagram showing a configuration of an OFDM modulating apparatus according to Embodiment 1 of the present invention;

FIG. 8 is a block diagram showing a configuration of an OFDM demodulating apparatus of Embodiment 1;

FIG. 9 is a waveform diagram showing a time waveform (FIG. 9A) of a signal after Nyquist formation and frequency property (FIG. 9B) of a signal after Nyquist formation;

FIG. 10 shows comparison of frequency bandwidth of an OFDM signal (FIG. 10A) which is added a Nyquist roll off factor by the embodiments with frequency bandwidth of a conventional OFDM signal (FIG. 10B);

FIG. 11 is a waveform diagram showing an image of a Nyquist wave of the embodiments modulated by a carrier;

FIG. 12 illustrates modulation operation of Embodiment 1, FIG. 12A shows an I axis signal for a first system, FIG. 12B shows a punctured signal of an I axis signal for a first system, FIG. 12C shows a punctured signal of an I axis signal for a second system and FIG. 12D shows a synthesized signal of an I axis signal for a first system and second system;

FIG. 13 illustrates modulation operation of Embodiment 1, FIG. 13A shows the portion of a signal for the first system that is kept and the portion that is removed, FIG. 13B shows the portion of a signal for the second system that is kept and the portion that is removed, FIG. 13C shows a waveform after synthesis and FIG. 13D shows a concept of synthesis;

FIG. 14 is a block diagram showing a configuration of an OFDM modulating apparatus of Embodiment 2; and

FIG. 15 is a block diagram showing a configuration of an OFDM demodulating apparatus of Embodiment 2.

### BEST MODE FOR CARRYING OUT THE INVENTION

Now, embodiments of the present invention will be described in detail with reference to the accompanying drawings.

### Embodiment 1

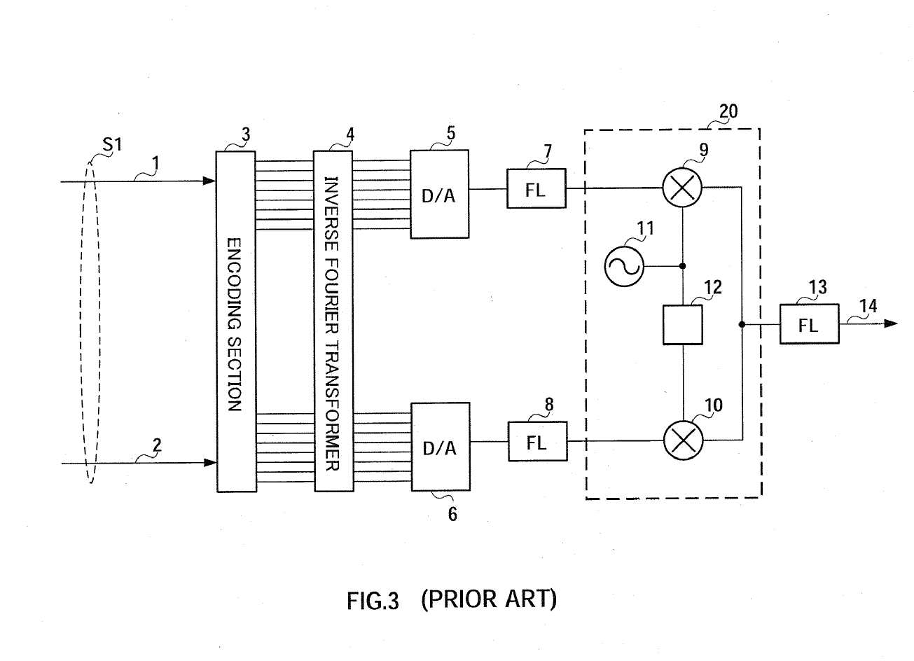

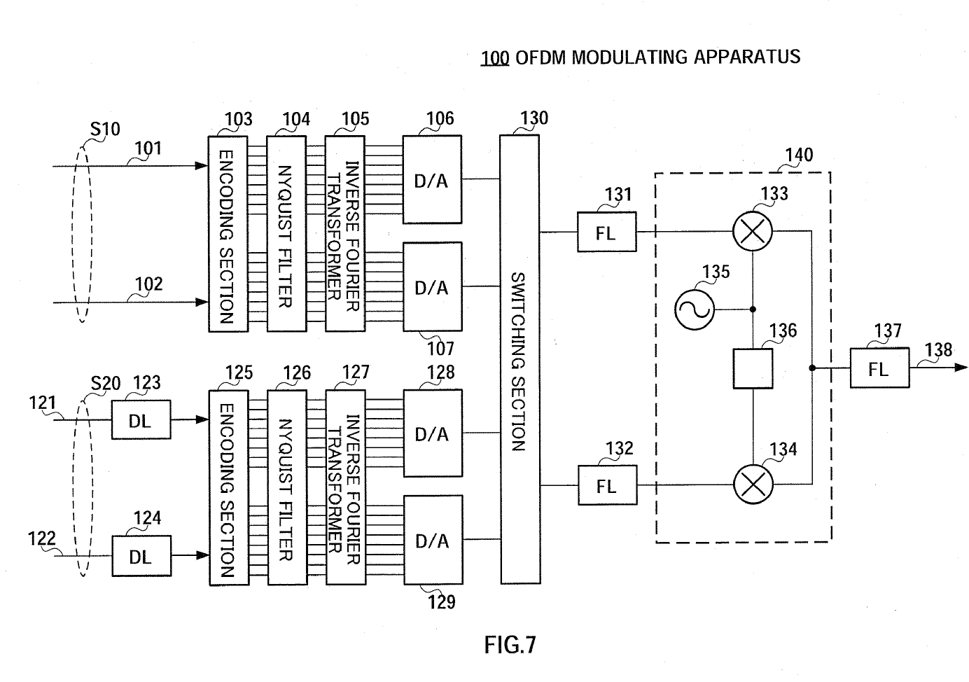

FIG. 7 shows the configuration of the OFDM modulating apparatus of the present embodiment. OFDM modulating apparatus 100 of the present embodiment can transmit twice as much information as the conventional OFDM modulating apparatus shown in FIG. 3, in substantially the same frequency bandwidth.

OFDM modulating apparatus 100 has two systems each transmitting the same amount of information as the conventional OFDM apparatus shown in FIG. 3. These will be referred to as the “first system” and the “second system,” input signal S10 is inputted in the first system and input signal S20 is inputted in the second system. These input signals S10 and S20 have the same transmission rate. Input signal S10 for the first system is formed with I axis signal 101 and Q axis signal 102, and input signal S20 for the second system is formed with I axis signal 121 and Q axis signal 122.

Input signal S10 for the first system is inputted directly to encoding section 103. By contrast with this, input signal S20 for the second system is given a delay of approximately ½ of the symbol period T by delayers (DL) 123 and 124 and then inputted to coding section 125. Each encoding section 103 and 125 adds error robustness to input signals S10 and S20 by performing encoding, and converts the encoded signals to N parallel signals corresponding to the number of OFDM subcarriers.

N parallel signals in the I domain and Q domain obtained respectively from encoding sections 103 and 125 are inputted to Nyquist filters 104 and 126. Further, for simplifying the drawing, FIG. 7 shows Nyquist filters 104 and 126 as one block. However, in reality, one Nyquist filters are provided for each I axis signal and Q axis signal as a pair outputted from encoding sections 103 and 125. The signals after Nyquist formation obtained from Nyquist filters 104 and 126 are provided to inverse Fourier transformers 105 and 127, respectively, and transformed into digital signals in the I domain and Q domain constituting N subcarriers. The output from inverse Fourier transformers 105 and 127 is inputted to switching section 130, which is a synthesis means, through digital-to-analogue (D/A) converters 106, 107, 128 and 129.

Switching section 130 switches and selects the signal inputted from inverse Fourier transform section 105 and the signal inputted from inverse Fourier transform section 127, at a cycle of ½ of the symbol period T, and outputs the selected signal. For example, switching section 130 selects and outputs the signals inputted from D/As 106 and 107 during the time period of 0 to T/2, and selects and outputs the signals inputted from D/As 128 and 129 during the time period of T/2 to T.

After unnecessary components are canceled by filters 131 and 132, the I axis signal and Q axis signal outputted from switching section 130 are inputted to quadrature modulation section 140. Quadrature modulation section 140 multiplies a cosine wave supplied from frequency source 135 providing a central frequency of an OFDM signal with an I axis signal at multiplier 133 and multiples a sine wave shifted by ½ of the phase by phase shifter 136, to a cosine wave of frequency source 135 with a Q axis signal at multiplier 134, thereby performing quadrature modulation of a cosine wave and a sine wave. After modulated outputs are added and then are canceled unnecessary frequency components by third filter 137, OFDM modulated signal 138 is obtained.

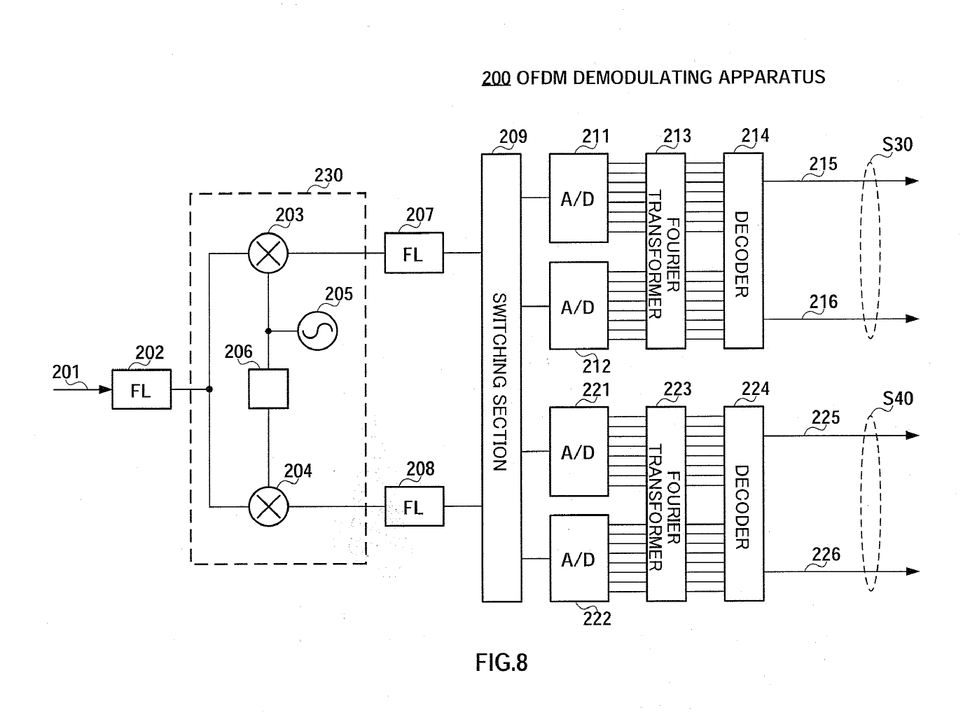

FIG. 8 shows the configuration of OFDM demodulating apparatus 200 that demodulates OFDM modulated signal 138 obtained from OFDM modulating apparatus 100 in FIG. 7. Demodulated input signal 201 (that is, a signal corresponding to OFDM modulated signal 138) is inputted to quadrature demodulation section 230 after unnecessary frequency components are canceled by filter 202.

Quadrature demodulation section 230 inputs the signal after the filtering to quadrature detection sections 203 and 204. In quadrature detection section 203, a cosine wave from detection frequency source 205 is multiplied. In quadrature detection section 204, a sine wave shifted by π/2 of the phase by phase shifter 206 is multiplied with a cosine wave of detection frequency source 205. The outputs of these quadrature detectors 203 and 204 are inputted to switching section 209 after unnecessary components are canceled by filter 207 and filter 208.

Switching section 209 divides the outputs of analogue-to-digital converters 211 and 212 into the I axis signal and Q axis signal for the first system and the I axis signal and Q axis signal for the second system, by dividing the period of the symbol period T by two into T/2. Switching section 209 sends out the divided I axis signal and Q axis signal for the first system to Fourier transformer 213 through analogue-to-digital (A/D) converters 211 and 212, and sends out the divided I axis signal and Q axis signal for the second system to Fourier transformer 223 through analogue-to-digital (A/D) converters 221 and 222.

Frequency domain information of the I axis signal and Q axis signal for the first system is changed to time domain information by Fourier transformer 213, and frequency domain information of the I axis signal and Q axis signal for the second system is changed to time domain information by Fourier transformer 223. Thus, the signals for the first system and second system are OFDM-modulated by Fourier transformers 213 and 223.

Fourier transformer 213 and Fourier transformer 223 performs Fourier transform which sets the integration period at ½ of the symbol period of the OFDM symbol. In addition, the integration period is shifted by ½ of the symbol period between Fourier transformer 213 and Fourier transformer 223. Thus, it is possible to transform the signals outputted alternately switching at ½ of the symbol period from switching section 209 to the signals before inverse Fourier transform, by Fourier transformers 213 and 223.

The OFDM demodulated outputs obtained by Fourier transformers 213 and 223 are sent out to decoders 214 and 224, respectively. Decoders 214 and 224 decode the inputted OFDM demodulated outputs and convert the results to serial signals. By this means, signal S30 formed with I axis signal 215 and Q axis signal 216 for the first system is outputted from decoder 214 and signal S40 formed with I axis signal 225 and Q axis signal 226 for the second system is outputted from decoder 224. That is, demodulated output signal S30 corresponding to input signal S10 for the first system in FIG. 7 is obtained and demodulated output signal S40 corresponding to input signal S20 for the second system in FIG. 7 is obtained. Thus, the signal modulated by OFDM modulating apparatus 100 shown in FIG. 7 is demodulated by OFDM demodulating apparatus 200 shown in FIG. 8.

Next, operation of the present embodiment is described.

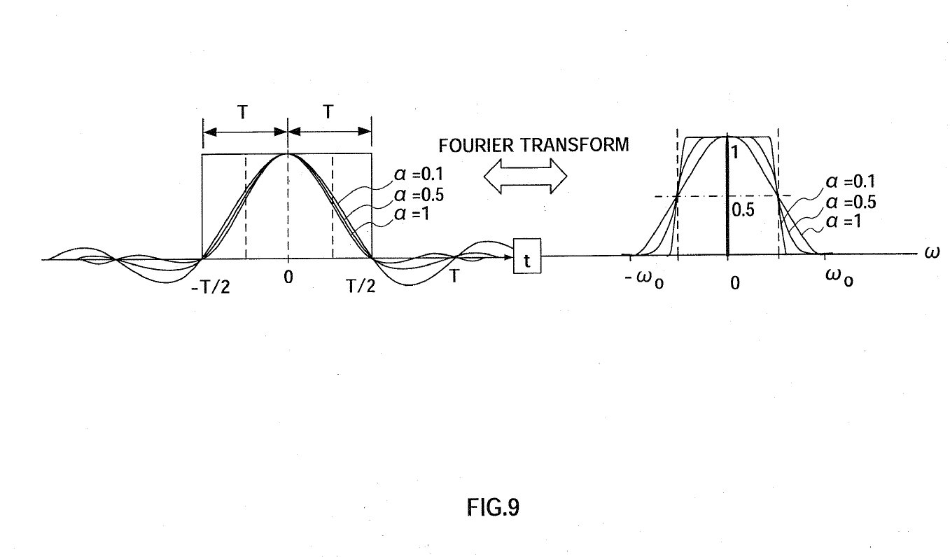

FIG. 9 shows the waveform formation performed in Nyquist filters 104 and 126 (FIG. 9A) of OFDM modulating apparatus 100 of the present embodiment and the spectrum of the waveform (FIG. 9B). As described above, the present embodiment performs Nyquist waveform formation by Nyquist filters 104 and 126. Nyquist waveform formation, as shown in FIG. 9, makes it possible to prevent interference between symbols and narrow the frequency bandwidth as much as possible. FIG. 9A shows the waveform of the signal after Nyquist formation in the time domain, where, if the roll-off factor is α, the waveform s(t) can be represented by:

$$\begin{matrix}[ 2 ] & \\ s ( t ) = A \frac{sin {ω}_{0} t}{{ω}_{0} t} {σ}_{0} ( t ) & ( Equation 2 ) \\ [ 3 ] & \\ {σ}_{0} ( t ) = \frac{{ω}_{0}}{π} [ \frac{1}{1 - {( \frac{2 {αω}_{0} t}{π} )}^{2}} ] & ( Equation 3 )\end{matrix}$$

Then, the frequency property Sₒ(ω) of the signal after Nyquist formation can be represented as follows using the roll-off factor α as a parameter:

$$\begin{matrix}[ 4 ] & \\ {S}_{0} ( ω ) = \{ \begin{matrix}1 \\ \frac{1}{2} + \frac{1}{2} cos [ \frac{π}{2 {αω}_{0}} ( \vert ω \vert - {ω}_{0} + {αω}_{0} ) ] \\ 0\end{matrix} \{ \begin{matrix}\vert ω \vert < {ω}_{0} - {αω}_{{0}_{1}} \\ {ω}_{0} - {αω}_{0} \leq \vert ω \vert \leq {ω}_{0} + {αω}_{0} \\ \vert ω \vert > {ω}_{0} + {αω}_{0}\end{matrix} & ( Equation 4 )\end{matrix}$$

FIGS. 9A and 9B show the characteristics when α is 0.1, 0.5 and 1.0.

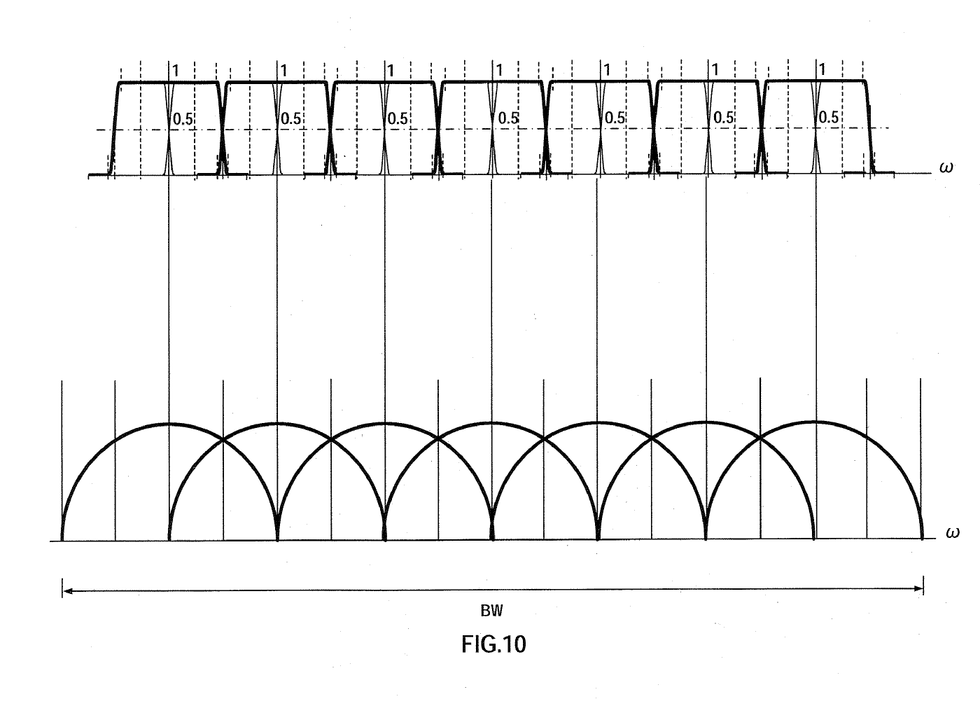

FIG. 10A shows the spectrum arrangement of an OFDM modulated signal according to the present embodiment using this Nyquist waveform. FIG. 10B shows the spectrum arrangement of a conventional OFDM modulated signal. Comparing the OFDM modulated signal according to the present embodiment shown in FIG. 10A with the conventional OFDM modulated signal shown in FIG. 10B, one frequency channel is accommodated in approximately ½ of the bandwidth of the conventional OFDM wave, and interference with the adjacent channels in the frequency domain becomes little.

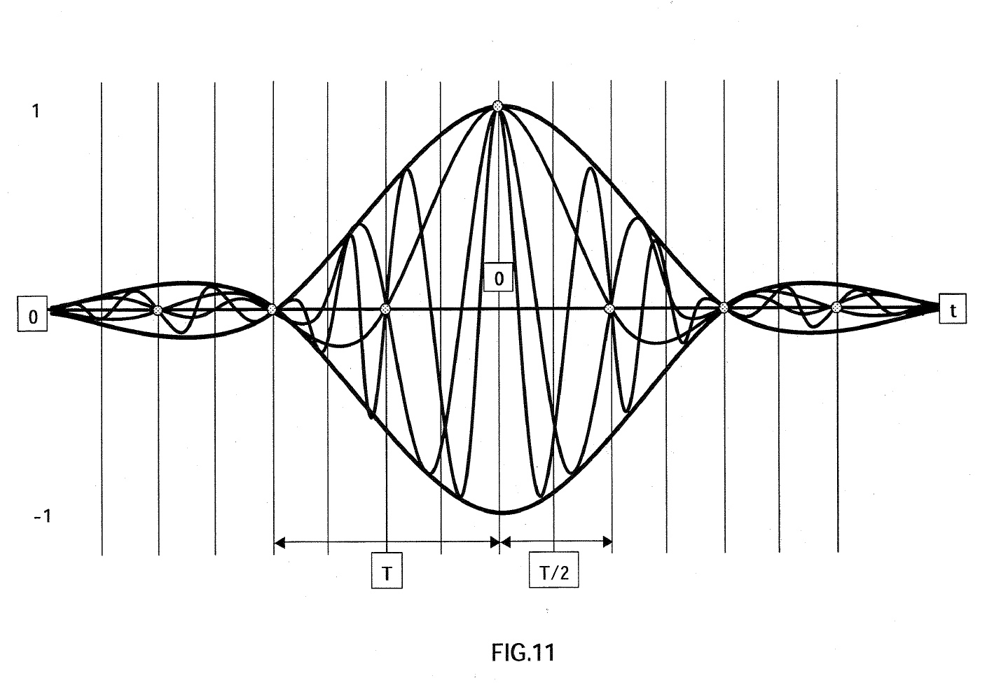

Further, FIG. 11 shows the image of this Nyquist wave modulated with a carrier. Particularly, when the carrier frequency is an odd harmonic of the symbol frequency, a null point is certain to be provided at every T/2 time as shown in FIG. 11, and the voltages at both ends become lower. That is, even if this portion is overlapped with other signals, interference becomes less. Further, even if this null portion is cut off, error rate in symbol transmission remarkably decreases.

Further, in OFDM, where the synchronized state of symbols are secured and individual carrier frequencies differ by integer times, a plurality of waveforms shown in FIG. 11 as an example are synthesized, so that amplitude at both ends remarkably decreases.

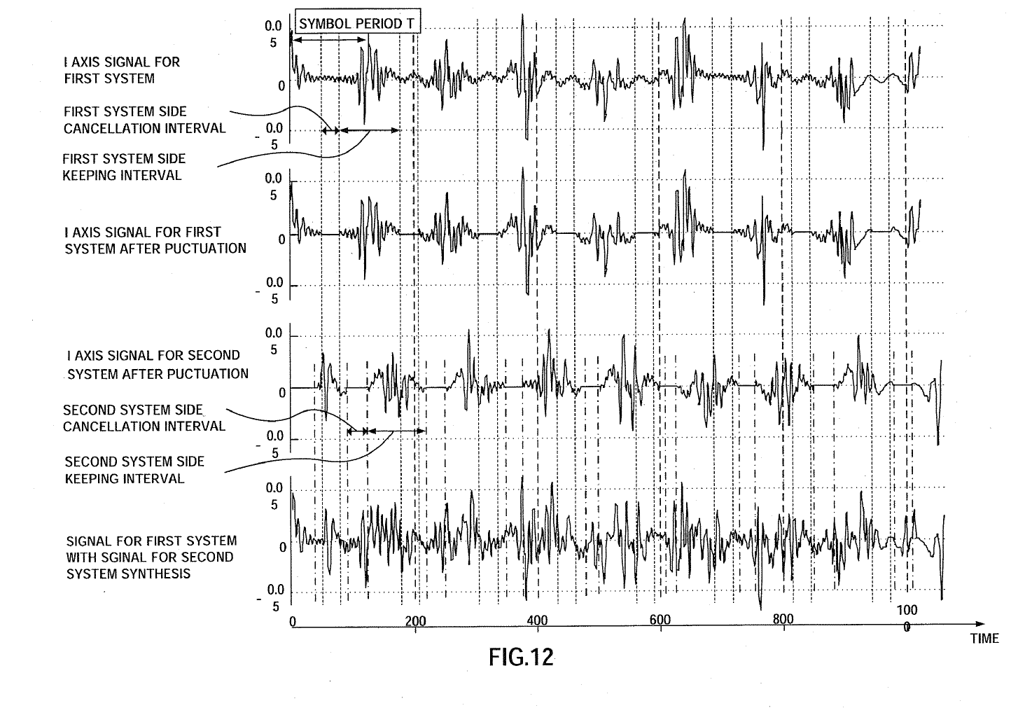

FIG. 12 shows each waveform on which actual simulation is performed. FIG. 12A shows a signal for the first system. FIG. 12A takes the I axis as an example, and modulation is performed such that the peak of information comes at time 0. At the center of symbol period T, as described above, the signal amplitude becomes very small. Then, it is possible to insert zero by cutting off this null portion as shown in FIG. 12B.

Meanwhile, as shown in FIG. 12C, the signal for the second system is provided with T/2 of time lag by delayers 123 and 124 with respect to the signal for the first system, and comes to a peak at a time delayed by T/2 from time 0.

That is, the signals for the second system become very small in amplitude near time 0 and time T, so that it is possible to insert zero by cutting off this null portion, similar to signals for the first system.

FIG. 12D shows synthesis of signals for the first system and signals for the second system with zero portions generated in this way. OFDM modulating apparatus 100 performs switching processing at switching section 130 of canceling (cutoff) and keeping of each one of these signals.

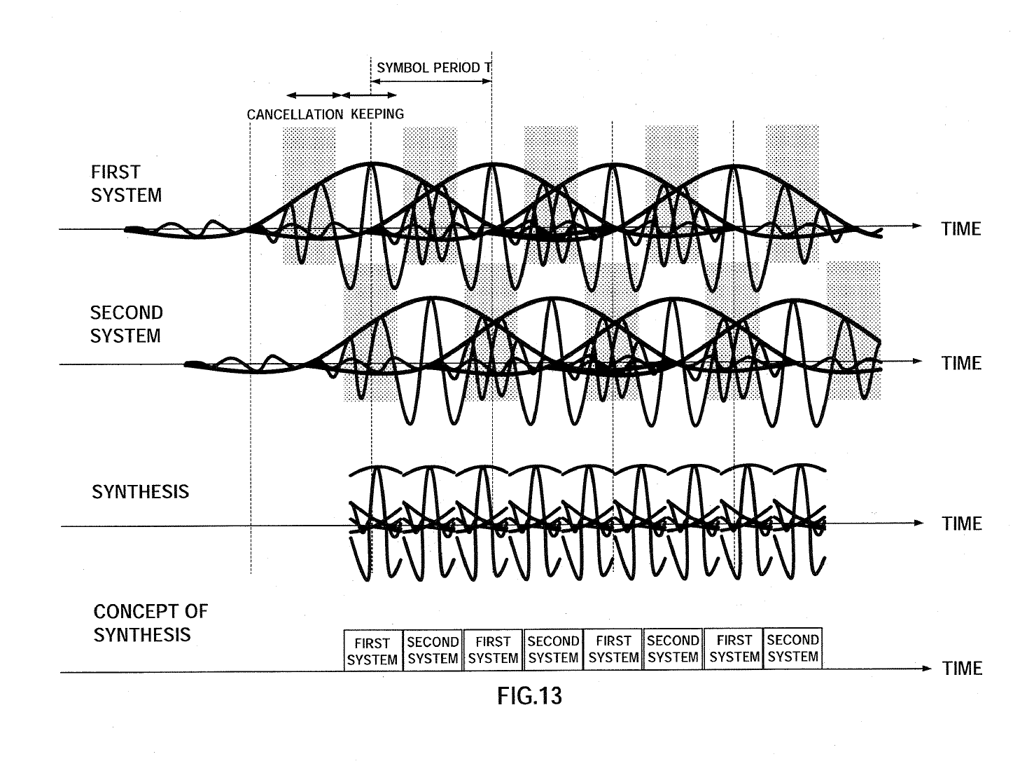

FIG. 13 models switching processing in FIG. 12. FIG. 13A shows the portion of the signal for the first system that is kept and the portion of the signal for the second system that is canceled. FIG. 13B shows the portion of the signal for the second system that is kept and the portion of the signal that is canceled. FIG. 13C shows the waveform after synthesis (output of switching section 130). FIG. 13D shows a concept of synthesis. As is understood from FIG. 13, OFDM modulating apparatus 100 according to the present embodiment switches at an interval of ½ of the symbol period T and selectively outputs signals for the first system and the second system, and synthesizes the signals for the two systems.

According to the present embodiment, Nyquist filters 104 and 126 for Nyquist formation of each signal for two systems (the first system and the second system), delayers 123 and 124 for delaying signals of one of the two systems by ½ of the symbol period T, inverse Fourier transformers 105 and 127 for performing OFDM processing on each symbol after Nyquist formation and switching section 130 for synthesizing signals for two systems by switching at an interval of ½ of the symbol period T and selectively outputting signals for two systems subjected to OFDM processing are provided, so that it is possible to divide and multiply two OFDM signals without interference from one another. As a result, it is possible to realize OFDM modulating apparatus 100 capable of achieving twice as much frequency use efficiency (that is, transmission of twice as much information as before in the conventional, same frequency bandwidth) as a conventional OFDM signal.

### Embodiment 2

In Embodiment 1, two OFDM signals are multiplexed by switching and alternately selecting the first system and the second system. However, this results in cutting off power of information in the respective systems, and leads to deterioration of the error rate to some degree.

Therefore, in the present embodiment, when OFDM signals for the first system and OFDM signals for the second system are synthesized, one of OFDM signals is not cut off at all. Instead, a method is proposed of keeping the original OFDM signals as much as possible by partially keeping OFDM signals before and after switching time and permitting partial overlaps of OFDM signals.

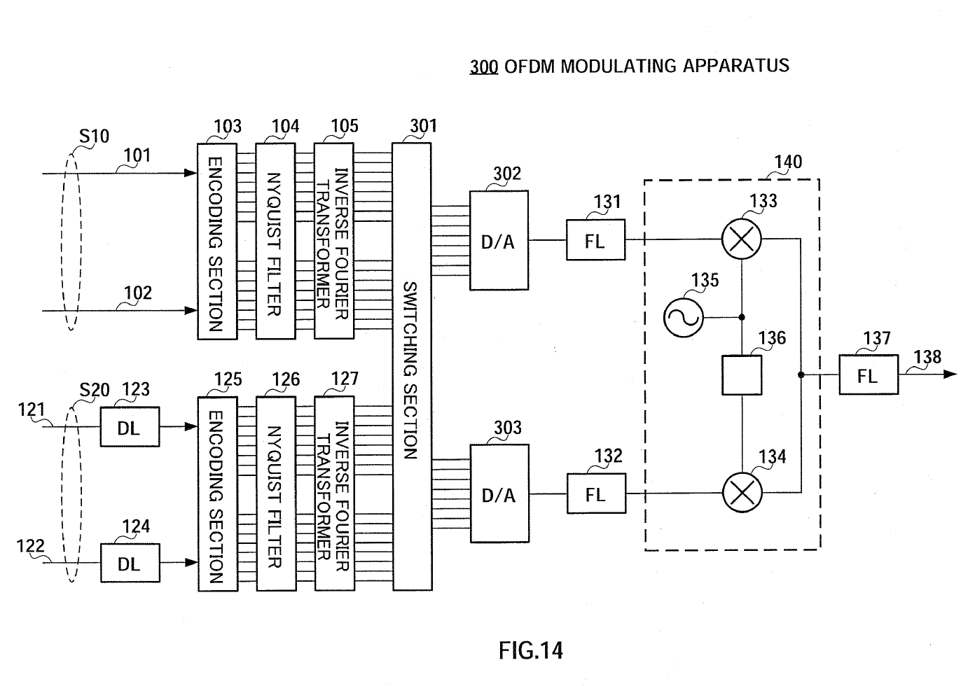

FIG. 14, in which the same reference numerals are allotted to the corresponding sections in FIG. 7, shows a configuration of an OFDM modulating apparatus of the present embodiment. Compared to OFDM modulating apparatus 100 as shown in FIG. 7, OFDM modulating apparatus 300 has the same configuration as OFDM modulating apparatus 100 other than the configuration that removes digital-to-analogue converters 106, 107, 128 and 129, adds digital-to-analogue converters 302 and 303 and differs in switching section 301.

That is, in OFDM modulating apparatus 300, a digital signal is inputted to switching section 301, and, by performing digital processing in switching section 301, OFDM signals for the first system and OFDM signals for the second system are synthesized by making these signals partially overlapped. That is, it is difficult to perform partial overlapping processing of two signals as described above by using analogue processing described in Embodiment 1. In the present embodiment, this processing is realized by configuring switching section 301 with a digital processing configuration.

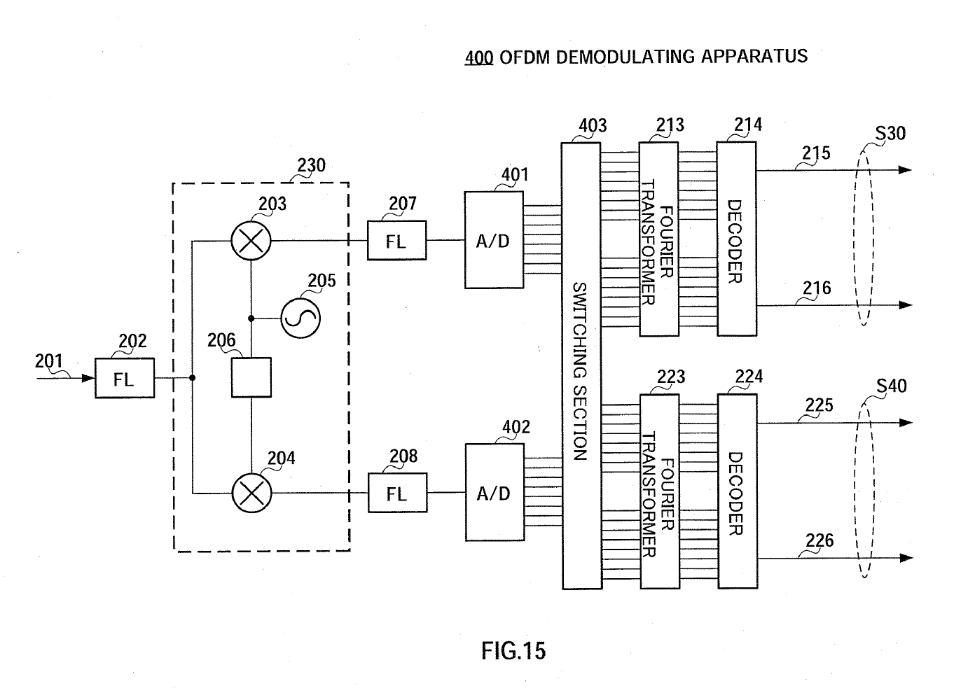

FIG. 15, in which the same reference numerals are allotted to the corresponding sections in FIG. 8, shows a configuration of OFDM demodulating apparatus 400 for demodulating OFDM modulated signals modulated by OFDM modulating apparatus 300 shown in FIG. 14. Compared to OFDM demodulating apparatus 200 in FIG. 8, OFDM demodulating apparatus 400 has the same configuration as OFDM demodulating apparatus 200 other than the configuration that adds analogue-to-digital converters 401 and 402, removes analogue-to-digital converters 211, 212, 221 and 222 and differs in a configuration of switching section 403.

That is, in OFDM demodulating apparatus 400, digital signals are inputted to switching section 403 and are divided to the I axis signal and the Q axis signal for the first system and the I axis signal and the Q axis signal for the second system by switching section 403. The I axis signal and Q axis signal for the first system are sent out to Fourier transformer 213, and the I axis signal and the Q axis signal for the second system are sent out to Fourier transformer 223. Switching section 403 performs digital processing and divides signals for the first system and signals for the second system which are partially overlapped during signal input by keeping the overlapped portion.

Thus, compared to Embodiment 1, decoders 214 and 224 perform decoding processing by sparingly using signals of the overlapped portion, so that the error rate characteristics of decoded data S30 and S40 is further improved than Embodiment 1.

Therefore, according to the present embodiment, in addition to Embodiment 1, a portion before and after switching time is kept and OFDM signals for the first system and OFDM signals for the second system are synthesized by making these signals partially overlapped, so that it is possible to realize OFDM communication with much better error rate characteristics than Embodiment 1.

Although cases have been described with above Embodiments 1 and 2 where delayers 123 and 124 are provided at a stage prior to encoding section 125, a section that adds delay is not limited to this, differential delay of ½ of the symbol period of the OFDM symbol may be given between first OFDM signals (OFDM signals for the first system) and second OFDM signals (OFDM signals for the second system), which are the targets of synthesis.

The present application is based on Japanese Patent Application No. 2005-015835, filed on Jan. 24, 2005, the entire content of which is expressly incorporated by reference herein.

### INDUSTRIAL APPLICABILITY

The present invention provides an advantage of improving frequency use efficiency in OFDM communication and is suitable for use in a radio system, such as wireless LAN, a cellular system and broadcasting system.

1. An orthogonal frequency division multiplexing modulating apparatus comprising:
a Nyquist formation section that performs Nyquist formation of a first pulse signal and a second pulse signal;
an inverse Fourier transform section that performs inverse Fourier transform on the first pulse signal and the second pulse signal after the Nyquist formation and obtains a first orthogonal frequency division multiplexing signal and a second orthogonal frequency division multiplexing signal;
a delay section that gives a delay of half of a symbol period of an orthogonal frequency division multiplexing symbol between the first orthogonal frequency division multiplexing signal and the second orthogonal frequency division multiplexing signal; and
a synthesizing section that switches and selects between the first orthogonal frequency division multiplexing signal and the second orthogonal frequency division multiplexing signal with the delay of half of the symbol period of the orthogonal frequency division multiplexing symbol at every half of the symbol period of the orthogonal frequency division multiplexing symbol and synthesizes the selected orthogonal frequency division multiplexing signal.

2. An orthogonal frequency division multiplexing modulating apparatus according to claim 1, wherein the synthesizing section keeps a portion of an orthogonal frequency division multiplexing signal before and after a switching time and synthesizes the first orthogonal frequency division multiplexing signal and the second orthogonal frequency division multiplexing signal such that the first orthogonal frequency division multiplexing signal and the second orthogonal frequency division multiplexing signal partially overlap.

3. An orthogonal frequency division multiplexing demodulating apparatus comprising:
a first Fourier transform section and a second Fourier transform section; and
a switching section for selectively switching a received orthogonal frequency division multiplexing modulated signal at half of a symbol period of an orthogonal frequency division multiplexing symbol to the first Fourier transform section or the second Fourier transform section.

4. An orthogonal frequency division multiplexing demodulating apparatus according to claim 3, wherein the first Fourier transform section and the second Fourier transform section set the integration period at half of the symbol period of an orthogonal frequency division multiplexing symbol and each integration period is shifted by half of a symbol period.

5. An orthogonal frequency division multiplexing modulating method comprising a step of selectively switching and synthesizing a first orthogonal frequency division multiplexing signal and a second orthogonal frequency division multiplexing signal formed after Nyquist formation and including respectively differential delay of half of the symbol period.

6. An orthogonal frequency division multiplexing demodulating method comprising the steps of:
switching a received orthogonal frequency division multiplexing modulated signal to an orthogonal frequency division multiplexing signal for a first system and a orthogonal frequency division multiplexing modulated signal for a second system at half of the symbol period of an orthogonal frequency division multiplexing symbol; and
performing Fourier transform on the orthogonal frequency division multiplexing modulated signal for the first system and the orthogonal frequency division multiplexing modulated signal for the second system individually.
